(19) United States
(12) Patent Application Publication
(10) Pub. No.: US 2024/0199914 A1
(43) Pub. Date: Jun. 20, 2024

(54) MODIFIED FILLER PARTICLES FOR ASPHALT SHINGLES

(71) Applicant: Owens Corning Intellectual Capital, LLC, Toledo, OH (US)

(72) Inventors: Hai Fu, Pataskala, OH (US); Nuttanit Pramounmat, Pataskala, OH (US); Jonathan Verhoff, Granville, OH (US); Gregory T. Hager, New Albany, OH (US)

(21) Appl. No.: 18/540,991

(22) Filed: Dec. 15, 2023

Related U.S. Application Data
(60) Provisional application No. 63/387,718, filed on Dec. 16, 2022.

(51) Int. Cl. C09D 195/00; E04D 1/20

(52) U.S. Cl. CPC C09D 195/00; E04D 1/20; E04D 1/26

(57) ABSTRACT

Roofing shingles provided herein include an asphalt-coated sheet, at least a portion of the asphalt-coated sheet comprises a plurality of granules disposed thereon. The asphalt-coated sheet includes a coating formed from an asphalt composition disposed on a substrate. The asphalt composition includes greater than about 40 wt. % of a filler, based on the weight of the total solids content of the asphalt composition, from about 0.01 wt. % to about 10 wt. % of a modifying agent selected from the group consisting of a fatty acid or salts thereof, metal hydroxide or a metal stearate, and asphalt. The resultant roofing shingle has a CD tear resistance of at least about 1,100 g as measured according to ASTM D1922 and a scrub loss of less than 0.60 g as measured according to ASTM D4977.

### CROSS-REFERENCE TO RELATED APPLICATION(S)

This application priority to and any benefit of U.S. Provisional Application No. 63/387,718, filed Dec. 16, 2022, the content of which is incorporated herein by reference in its entirety.

### BACKGROUND

Asphalt-based roofing materials, such as roofing shingles, roll roofing, and commercial roofing, are installed on the roofs of buildings to provide protection from the elements, and to provide a pleasing aesthetic appearance. Various roofing materials, including asphalt-based roofing shingles, are often constructed of a substrate such as a glass fiber mat or an organic felt, an asphalt coating on the substrate, and a surface layer of granules embedded in the asphalt coating.

Asphalt-based roofing shingles are generally made by mixing asphalt with an inorganic filler material to make a filled asphalt coating. The roofing substrate is then coated on each side and saturated with the filled asphalt coating, forming an asphalt-coated substrate that may subsequently be coated with a layer or granules, and other optional coating materials to form a roofing shingle.

Conventional filled asphalt coatings generally include no greater than about 68 wt. % of filler, in order to achieve sufficient properties for both the coating itself (i.e., shear viscosity, etc.) and the shingle produced therefrom. Although it is well known that filler material is less expensive than the asphalt itself, efforts to increase the amount of filler used in a filled asphalt coating generally leads to increased coating viscosity, which then requires processing adjustments, such as increasing the temperature of the filled asphalt coating and/or reducing the processing line speed. Such processing adjustments not only impact the productivity of the shingle manufacturing process, but also impact and degrade the overall shingle properties.

Accordingly, there is a continuing need to improve shingle quality by modifying the filled asphalt coating in such a way that provides improved shingle properties, including the adhesion of granules to the asphalt coating of a shingle and allows for the adjustment in filler content to improve shingle manufacturing productivity.

### BRIEF SUMMARY

Various aspects of the present inventive concepts described herein are directed to a roofing shingle comprising an asphalt-coated sheet including an asphalt coating composition disposed on a substrate, wherein at least a portion of the asphalt-coated sheet comprises a plurality of granules disposed thereon. The asphalt coating composition may include greater than about 40 wt. % of a filler, including greater than 65 wt. %, or greater than 68 wt. %, or greater than 69 wt. % filler, based on a total weight of the asphalt composition, from about 0.01 wt. % to about 10 wt. % of at least one modifying agent comprising a fatty acid, a metal hydroxide, a salt of a fatty acid, or mixtures thereof; and asphalt, wherein the percentages are based on the weight of the total solids content of the asphalt composition. The roofing shingle has a cross-direction (“CD”) tear resistance of at least about 1,700 g as measured according to ASTM D1922 and a granule scrub loss of less than 1.0 g as measured according to ASTM D4977.

In any of the exemplary aspects, the salt of a fatty acid may be a metal stearate and the fatty acid may be stearic acid, lauric acid, myristic acid, palmitic acid oleic acid, linoleic acid, or mixtures thereof. In some instances, the modifying agent may include one or more of stearic acid, calcium stearate, zinc stearate, or calcium hydroxide.

The roofing shingle disclosed herein has a granule scrub loss that is improved by greater than or equal to about 10% based on a lost mass as compared to a lost mass of a comparable shingle not including the modifying agent, and a CD tear resistance that is greater than or equal to about 1,700 g. In any of the exemplary aspects, the granule scrub loss may be less than or equal to about 0.6 g.

Further aspects of the present inventive concepts disclosed herein are directed to a method of manufacturing an asphalt-coated sheet comprising combining a filler and at least one modifying agent including fatty acids, salts of fatty acids, metal hydroxides, and mixtures thereof, to form a modified filler. The modified filler is then combined with asphalt to form an asphalt coating composition, which is then applied to a substrate, thereby forming an asphalt-coated sheet. The filler may be included in an amount of greater than about 65 wt. % and the modifying agent is included in an amount of from about 0.01 wt. % to about 10 wt. %, wherein the percentages are based on the weight of the total solids content of the asphalt composition. In some instances, the salt of fatty acid is a metal stearate and the fatty acid is stearic acid, lauric acid, myristic acid, palmitic acid, oleic acid, linoleic acid, or mixtures thereof. In these or other embodiments, the modifying agent may be any of stearic acid, calcium hydroxide, calcium stearate, zinc stearate, or mixtures thereof. The modifying agent may be present in a powder or liquid form.

Further aspects of the present inventive concepts disclosed herein are directed to an asphalt-coated sheet having improved surface morphology comprising an asphalt coating composition disposed on a substrate, the asphalt coating composition having a top surface. The asphalt coating composition comprises greater than about 68 wt. % of a filler, such as greater than 69 wt. % filler, or greater than 70 wt. % filler, based on the weight of the total solids content of the asphalt composition, from about 0.01 wt. % to about 10 wt. % of at least one modifying agent comprising a fatty acid, a metal hydroxide, a salt of a fatty acid, or mixtures thereof, and asphalt. The asphalt coating composition includes a reduced presence of raised asphaltene fractions at the top surface by at least 10%, compared to an otherwise identical asphalt-coated sheet not including the modifying agent.

### BRIEF DESCRIPTION OF THE DRAWINGS

The general inventive concepts, as well as embodiments and advantages thereof, are described in greater detail, by way of example, with reference to the drawings in which:

FIG. 1 is a schematic elevation view of an apparatus for making shingles according to one or more embodiments shown and described herein;

FIG. 2 is a perspective view of a laminated shingle formed on the apparatus of FIG. 1 and including the asphalt composition according to one or more embodiments shown and described herein;

FIG. 3 is a graph of the shear (in cP; Y-axis) at 400° F. for various samples (X-axis) as set forth in Example 1 described herein;

FIGS. 4(a)-(e) are interval plots of the average granule adhesion (in g; Y-axis) for samples (X-axis) as set forth in Example 2 described herein; and

FIGS. 5(a) and (b) are interval plots of the average CD Tear Resistance (in g; Y-axis) for samples (X-axis) as set forth in Example 2 described herein.

FIG. 5(c) is an interval plot of the bond performance (as average load in pounds) as set forth in Example 2 described herein.

FIG. 5(d) is an interval plot of the lap shear face to face sticking (in pounds) as set forth in Example 2 described herein.

FIG. 6(a) is a pictorial illustration of standard oxidized asphalt coating composition that includes 70 wt. % of a non-modified calcium carbonate filler.

FIG. 6(b) is a pictorial illustration of a coating composition comprising a standard oxidized asphalt base material and 70 wt. % of calcium carbonate filler modified with calcium stearate.

FIG. 7(a) is a pictorial illustration of standard oxidized asphalt coating composition that includes 70 wt. % of a non-modified calcium carbonate filler.

FIG. 7(b) is a pictorial illustration of a coating composition comprising a standard oxidized asphalt base material and 70 wt. % of calcium carbonate filler modified with calcium stearate.

FIG. 8 is a graphical illustration of the shear viscosity per shear rate for a conventional filled asphalt coating composition, compared to an inventive asphalt coating composition including a modifying agent.

FIG. 9 is a graphical illustration of the mean force of adhesion for conventional filled asphalt coating compositions, compared to inventive asphalt coating compositions including a modifying agent.

FIG. 10 is a graphical illustration of the surface energy (mN/m) for conventional, unmodified calcium carbonate filler particles, compared to calcium carbonate filler particles modified with 0.5 wt. % of a modifying agent, as described herein.

FIG. 11 is a graphical illustration of the acid-base surface energy of a treated and unmodified filler sample as function of probe molecule coverage on the samples, measured using inverse gas chromatography.

FIG. 12 is a graphical illustration of the surface polarity index of a treated and unmodified filler sample as function of probe molecule coverage on the samples, measured using inverse gas chromatography.

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing exemplary embodiments only and is not intended to be limiting of the exemplary embodiments.

Accordingly, the general inventive concepts are not intended to be limited to the specific embodiments illustrated herein. Although other methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least each numerical parameter should be construed in light of the number of significant digits and ordinary rounding approaches.

Notwithstanding that the numerical ranges and parameters setting forth the broad scope of the exemplary embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein. Moreover, any numerical value reported in the Examples may be used to define either an upper or lower end-point of a broader compositional range disclosed herein.

The general inventive concepts encompass an asphalt composition including a filler material that has been modified with a modifying agent and roofing shingles formed therefrom. In addition to improving shingle performance, such as granule adhesion, the modified filler can enable the use of an increased amount of filler in the asphalt composition without negatively impacting the shingle properties. The asphalt composition may include a filler material that is modified with a modifying agent prior to being incorporated into the asphalt composition. The filled asphalt composition can include greater than or equal to about 25 wt. %, greater than about 30 wt. %, greater than about 40 wt. %, greater than about 50 wt. %, greater than about 60 wt. %, or greater than about 65 wt. % of the modified filler, based on the weight of the total solids content of the asphalt composition. The modifying agent may be present in an amount of from about 0.01 wt. % to about 10 wt. %, based on the weight of the total solids content of the asphalt composition. When the filled asphalt composition is applied to a shingle, the shingle has a CD tear resistance of at least about 1,100 grams (g), at least about 1.250 g, at least about 1,300 g, at least about 1,1400 g, at least about 1,500 g, at least about 1,700 g, at least about 1,750 g, at least about 1,800 g, at least about 1,850 g, at least about 1,900 g, or at least about 1,950 g, as measured according to ASTM D1922, and a scrub loss of less than 1.00 g, less than 0.75 g, or less than 0.60 g, as measured according to ASTM D4977.

The modified filler material may comprise one or more types of filler particles at least partially coated with a modifying agent. The filler particles may comprise any variety of ground inorganic particulate matter, such as, for example, ground limestone, dolomite or silica, talc, sand, cellulosic materials, fiberglass, calcium carbonate, carbon, clay, perlite, mica, fumed silica, carbon black, wollastonite, reclaimed or recycled asphalt shingle content, and combinations thereof. The filler material may comprise particles having average (median) particle sizes in the range of 0.3 microns to 200 microns, including an average particle size range of 1 micron to 180 microns, 5 microns to 175 microns, 15 microns to 150 microns, 25 microns to 125 microns, 30 microns to 115 microns, 35 microns to 100 microns, 40 microns to 85 microns, and 45 microns to 60 microns, including all endpoints and subranges therebetween. In any of the exemplary embodiments, the filler particles may have an average particle size from 30 microns to 60 microns. In any of the exemplary embodiments, the modifying agent at least partially coated onto the surface of the filler particles to form the modified filler prior to adding the filler to the asphalt base composition. Alternatively, or in addition to modifying the filler particles, the modifying agent may be added directly into the asphalt before, simultaneously, or after the filler material is added to the asphalt.

The modifying agent may comprise fatty acids and anionic surfactants, including metal salts of a fatty acids, metal hydroxides, or mixtures thereof. Suitable fatty acids include stearic acid, lauric acid, myristic acid, palmitic acid oleic acid, linoleic acid, and the like. Suitable metal salts of fatty acids include, but are not limited to, metal laurates, metal myristates, metal palmitates, and metal stearates. Exemplary metal laurates include, but are not limited to, zinc laurate, calcium laurate, aluminum laurate, and magnesium laurate. Exemplary metal myristates include, but are not limited to, zinc myristate, calcium myristate, aluminum myristate, and magnesium myristate. Exemplary metal palmitates include, but are not limited to, zinc palmitate, calcium palmitate, aluminum palmitate, and magnesium palmitate. Exemplary metal stearates include, but are not limited to, zinc stearate, calcium stearate, aluminum stearate, and magnesium stearate. Exemplary metal hydroxides include, for example, aluminum hydroxide, calcium hydroxide, magnesium hydroxide, and the like. Additionally or alternatively, the modifying agent may comprise a silane or a nonionic surfactant. Suitable nonionic surfactants can include fatty alcohols, titanates, aluminates, sodium oleate, organic oligomers, and water-soluble polymers, including but not limited to polyacrylic acid. In any of the exemplary aspects herein, the modifying agent may exclude or be free of an amine. In such aspects, the modified filler is also free or substantially free of amines. The particular modifying agent may be selected based at least in part on the type of asphalt included in the asphalt composition.

The modifying agent can be in liquid or powder form, depending on the particular modifying agent being used. The modifying agent may be mixed with the filler to form the modified filler using any method known and used in the art. In some instances, the modifying agent is added in liquid form to at least a portion of the filler, mixed, and allowed to dry for a period of time before being mixed with the asphalt and optionally additional filler. Alternatively, the modifying agent may be mixed in powdered form with the filler. Regardless of the form of the modifying agent or the method of mixing used, the combination of the modifying agent with the filler is effective to incorporate the functional group of the modifying agent onto the filler, thereby modifying the surface energy of the filler. For example, when calcium carbonate filler is mixed with a metal salt of a fatty acid, such as a metal stearate, the modified calcium carbonate particles may have a decreased surface energy, increased hydrophobicity, and increased dispersive chemistry, as compared to unmodified calcium carbonate particles. A decrease in surface energy allows the filler to bond more effectively with asphalt than unmodified filler, since the polar calcium particles are not as compatible with asphalt as the non-polar tail of a metal stearate. In contrast, amine-based materials are not effective modifying agents, as such are more hydrophilic and not effective to reduce the surface energy of the filler particles.

As another example, when calcium carbonate filler is mixed with a hydroxide, the modified calcium carbonate particles may have a reduced surface energy and surface polarity, as compared to unmodified calcium carbonate. There are various methods of measuring surface energy, such as measuring surface free energy (SFE) using an optical tensiometer or measuring the acid-base (or polar) surface energy through the use of inverse gas chromatography. In the first instance, SFE is measured through sessile drop measurements with the optical tensiometer. In any of the embodiments, the modified filler has a SFE (measured via a tensiometer) below 35 mN/m, such as, for example, a surface energy that is no greater than 33 mN/m, no greater than 30 mN/m, no greater than 28 mN/m, no greater than 25 mN/m, no greater than 23 mN/m, and no greater than 20 mN/m. In any of the exemplary embodiments, the modified filler has an acid-base surface energy (measured via inverse gas chromatography) no greater than 2 mJ/m², such as, for example, no greater than 1.9 mJ/m², no greater than 1.8 mJ/m², no greater than 1.7 mJ/m², no greater than 1.6 mJ/m², and no greater than 1.5 mJ/m². For each of the above measurements, the relative humidity and temperature are 0% and 30° C., respectively.

In any of the embodiments, the modification of the filler can change (e.g., increase or decrease) the surface energy of the filler (either SFE or acid-base surface energy) as compared to the surface energy of the unmodified filler by greater than or equal to about 10%, greater than or equal to about 15%, greater than or equal to about 20%, greater than or equal to about 25%, greater than or equal to about 30%, greater than or equal to about 35%, or greater than or equal to about 40%, including any and all ranges and subranges therein.

Another method for characterizing the surface of the filler particles is through surface polarity or “wettability” index, which is calculated by dividing the acid-base surface energy with the total dispersive (the component of surface energy that results from the dispersion of the electron clouds in the molecules on the surface of the material) and acid-base surface energy measured. In any of the exemplary aspects, the modified filler has a surface polarity index of no greater than 0.04, such as, for example, no greater than 0.037, no greater than 0.035, no greater than 0.034, or no greater than 0.033.

The modifying agent may be present in the asphalt composition in an amount of from about 0.01 wt. % to about 10 wt. %, based on the weight of the total solids content of the asphalt composition, including from about 0.02 wt. % to about 8 wt. %, from about 0.03 wt. % to about 6 wt. %, from about 0.04 wt. % to about 4 wt. %, and from about 0.05 wt. % to about 2 wt. %, based on the weight of the total solids content of the asphalt composition, including all endpoints and subranges therebetween. For example, the modifying agent can be present in the asphalt composition an amount of from about 0.075 wt. % to about 1.9 wt. %, from about 0.09 wt. % to about 1.75 wt. %, from about 0.10 wt. % to about 1.6 wt. %, from about 0.15 wt. % to about 1.5 wt. %, from about 0.2 wt. % to about 1.3 wt. %, from about 0.25 wt. % to about 1.15 wt. %, and from about 0.3 wt. % to about 1.05 wt. %, based on the weight of the total solids content of the asphalt composition, including any and all ranges and subranges therein. The modifying agent may be present in the asphalt composition in an amount from about 0.05 wt. % to about 1.5 wt. %, from about 0.08 wt. % to about 1.5 wt. %, from about 0.1 wt. % to about 1.5 wt. %, from about 0.14 wt. % to about 1.5 wt. %, from about 0.18 wt. % to about 1.5 wt. %, from about 0.2 wt. % to about 1.5 wt. %, from about 0.27 wt. % to about 1.5 wt. %, from about 0.05 wt. % to about 1.25 wt. %, from about 0.10 wt. % to about 1.25 wt. %, from about 0.25 wt. % to about 1.25 wt. %, from about 0.50 wt. % to about 1.25 wt. %, from about 0.75 wt. % to about 1.25 wt. %, from about 1.0 wt. % to about 1.25 wt. %, from about 0.05 wt. % to about 1.0 wt. %, from about 0.10 wt. % to about 1.0 wt. %, from about 0.25 wt. % to about 1.0 wt. %, from about 0.50 wt. % to about 1.0 wt. %, or from about 0.75 wt. % to about 1.0 wt. %, based on the weight of the total solids content of the asphalt composition, including any and all ranges and subranges therein. In any of the exemplary embodiments, the modifying agent may be present in the asphalt composition in an amount that is less than 1.0 wt. %. based on the weight of the total solids content of the asphalt composition.

As mentioned above, it was surprisingly discovered that by at least partially modifying the filler material with the modifying agent, a higher concentration of filler material could be incorporated into the asphalt composition without negatively impacting the roofing shingle properties. Conventional filled asphalt coatings for shingles generally include no more than about 68 wt. % filler. However, it was discovered that at least partially modifying the filler particles allowed for the use of increased filler concentrations that are greater than 68 wt. %, including for example, at least 69 wt. %, at least 70 wt. %, at least 72 wt. %, at least 75 wt. %, or at least 77 wt. %, based on the weight of the total solids content of the asphalt composition. Alternatively, by at least partially modifying the filler material with the modifying agent, conventional concentrations of filler material can be used in the asphalt composition, and this will result in improved roofing shingle properties.

The modified filler material may be present in the asphalt composition in an amount greater than or equal to about 40 wt. %, based on the weight of the total solids content of the asphalt composition. For example, the modified filler material can be present in an amount of greater than or equal to about 42 wt. %, greater than or equal to about 45 wt. %, greater than or equal to about 50 wt. %, greater than or equal to about 55 wt. %, greater than or equal to about 60 wt. %, greater than or equal to about 65 wt. %, greater than or equal to about 68 wt. %, greater than equal to about 70 wt. %, greater than or equal to about 72 wt. %, or greater than or equal to about 75 wt. %, based on the weight of the total solids content of the asphalt composition. In any of the embodiments, the modified filler material may present in an amount of from about 40 wt. % to about 80 wt. %, from about 50 wt. % to about 78 wt. %, from about 60 wt. % to about 76 wt. %, from about 65 wt. % to about 75 wt. %, from about 66 wt. % to about 74 wt. %, or from about 68 wt. % to about 72 wt. %, based on the weight of the total solids content of the asphalt composition, including any and all ranges and subranges therein.

In some instances, the modified filler material may be present in the asphalt composition in an amount greater than or equal to about 25 wt. %, such as greater than or equal to about 30 wt. %, or greater than or equal to about 35 wt. %, based on the weight of the total solids content of the asphalt composition.

The balance of the filled asphalt composition comprises an asphalt base material, which is understood to mean any asphalt base material composed of one or more asphalt bases and optionally comprising one or more additives. As used herein the term “asphalt” is meant to include any bituminous materials produced from petroleum refining, including residua from atmospheric distillation, from vacuum distillation, and from solvent de-asphalting units, recycled asphalt streams, such as re-refined motor oil bottoms. Mixtures of different asphalts can also be used. The exemplary aspects disclosed herein can also be used with natural bitumen, such as the products extracted from the oil sands in Alberta or asphalts derived from oil sands by various refinery processes.

The asphalt base material may be visbroken and/or deasphalted (i.e., propane deasphalted asphalt) and/or partially or fully oxidized. In some exemplary embodiments, the asphalt base material may be prepared using a wide array of paving grade asphalt materials, such as different types of paving asphalts used independently or as a mixture with various types of asphalt, such as, for example, solvent extracted asphalt, naturally occurring asphalt, synthetic asphalt, and recycled asphalt. The various asphalt bases can be combined with one another in order to obtain the best technical compromise.

The asphalt base material may comprise one or more of flux, paving grade asphalt or paving grade asphalt blends, propane deasphalted asphalt, partially or fully oxidized asphalt, non-oxidized asphalt, and/or blends thereof.

The asphalt base material may optionally further comprise at least one polymer additive and/or at least one fluxing agent. The polymer additive may comprise an elastomeric radial or linear polymer. The polymer additive may comprise a copolymer such as a linear or radial copolymer. In some embodiments the polymer additive comprises one or more of atactic polypropylene (APP), isotactic polypropylene (IPP), styrene-butadiene-styrene rubber (SBS), polychloroprene; polynorbornène; chloroprene rubber (CR), natural and reclaimed rubbers (including ground tire rubber), butadiene rubber (BR), acrylonitrile-butadiene rubber (NBR), isoprene rubber (IR), styrene-polyisoprene (SI), butyl rubber, ethylene propylene rubber (EPR), ethylene propylene diene monomer rubber (EPDM), polyisobutylene (PIB), chlorinated polyethylene (CPE), styrene ethylene-butylene-styrene (SEBS), and vinylacetate/polyethylene (EVA), ethylene-methylacrylate copolymers (EMA); copolymers of olefins and unsaturated carboxylic esters such as ethylene-butylacrylates (EBA); polyolefinic copolymers; polyolefins such as polybutenes (PB) and polyisobutenes (PIB); copolymers of ethylene and esters of acrylic acid or methacrylic acid or maleic anhydride; copolymers and terpolymers of ethylene and glycidyl methacrylate; ethylene/propylene copolymers; and rubber. In other exemplary embodiments, the polymer additive comprises a linear polymer or a combination of linear and radial polymers. Examples of polymer modifiers are also disclosed in U.S. Pat. No. 4,738,884 to Algrim et al., U.S. Pat. No. 3,770,559 to Jackson, and U.S. Pat. No. 11,028,591 to LaTorre et al., the contents of which are incorporated herein by reference in their entirety. In some exemplary embodiments, the asphalt is modified with styrene-butadiene-styrene rubber (SBS).

The polymer additive may be included in the asphalt base material in an amount from about 0.5 wt. % to about 20.0 wt. %, based on the weight of the total solids content of the asphalt composition (excluding any filler). The polymer additive may be included in an amount from about 1.0 to about 15.0 wt. %, or from about 1.5 to about 10.0 wt. %, or from about 2.0 to about 7.0 wt. %, or from about 3.0 to about 6.5 wt. %, or about 5.0 to about 6.0 wt. %, based on the weight of the total solids content of the asphalt composition (excluding the filler).

Additional additives may also be included in the asphalt composition. Such additives include, for example, vulcanization and/or crosslinking agents which are able to react with the polymer, notably with the elastomer and/or the plastomer, which may be functionalized and/or which may comprise reactive sites. As vulcanization agents, mentions may be made by way of example of sulphur-based vulcanization agents and its derivatives. Such vulcanization agents are generally introduced in a content of from 0.01% to 30% by weight, with respect to the weight of the elastomer. As crosslinking agents, mentions may be made by way of example of cationic reticulation agents such as mono or polyacids; carboxylic anhydrides; esters of carboxylic acids; sulfonic, sulfuric, phosphoric or chloride acids; phenols. Such crosslinking agents are generally introduced in a content of from 0.01% to 30% by weight, with respect to the weight of the polymer. These agents are likely to react with the functionalized elastomer and/or plastomer. They may be used to complete and/or to substitute vulcanization agents.

Other materials suitable for use in the asphalt composition include tackifying resins and other types of natural and synthetic rubber materials and thermoplastic polymers. Additionally, recycled roof tear-off materials, such as shingles, may be included in the asphalt composition. Recycled shingles may be processed in a wide variety of different ways to allow the material to be used in the composition.

The asphalt composition including the modified filler can be used as a coating on substrates for use in the manufacture of shingles and other roofing products, such as roofing underlayments. The asphalt composition may further be used in applications, such as sealants, adhesives, self-adhered membranes, and the like. In any of the exemplary embodiments, one or more types of granules may be applied to a coated surface of a substrate. Granules can include, for example, traditional roofing granules and other specialty granules. The filled asphalt composition exhibits improved granule adhesion, as described in greater detail below.

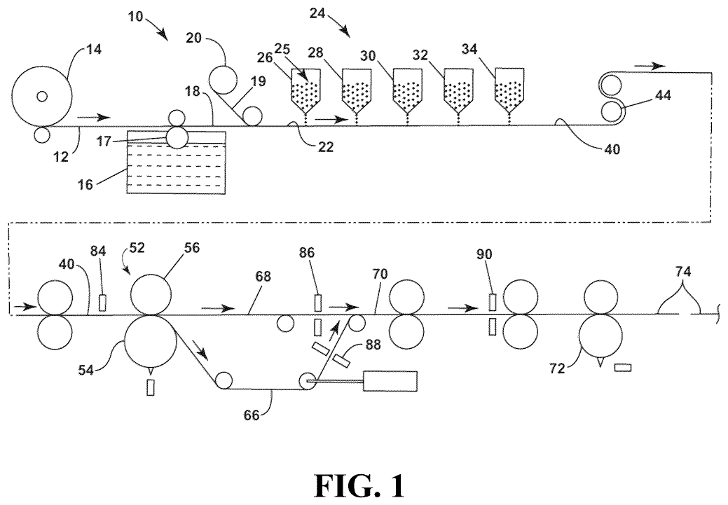

FIG. 1 illustrates an example apparatus 10 for manufacturing an asphalt-based roofing material according to a manufacturing process wherein a continuous sheet is passed in a machine direction (indicated by the arrows) through a series of manufacturing operations. The sheet can pass at a speed of at least about 200 feet/minute (61 meters/minute) and can pass at a speed within the range of between about 450 feet/minute (137 meters/minute) and about 800 feet/minute (244 meters/minute) or even above 800 feet/minute. The sheet, however, can move at any desired speed.

The manufacturing process continues as the continuous sheet of substrate or shingle mat 12 is payed out from a roll 14. The substrate can be any type known for use in reinforcing asphalt-based roofing materials, such as a non-woven web of glass fibers. The shingle mat 12 is fed through a coater 16 where an asphalt coating is applied to the shingle mat 12. The asphalt coating can be applied in any suitable manner. In one example, the shingle mat 12 contacts a roller 17, which is in contact with a supply of hot, melted asphalt. The roller 17 completely covers the shingle mat 12 with a tacky coating of hot, melted asphalt to define a first asphalt coated sheet 18. Alternatively, the asphalt coating can be sprayed on, rolled on, or applied to the first asphalt coated sheet 18 by any other suitable means.

Next, and optionally, a continuous strip of a reinforcement material or reinforcement tape 19, is payed out from a roll 20. The reinforcement tape 19 adheres to the first asphalt coated sheet 18 to define a second asphalt coated sheet 22. In any of the exemplary embodiments, the reinforcement tape 19 can be attached to the first asphalt coated sheet 18 by the adhesive mixture of the asphalt in the first asphalt coated sheet 18. Alternatively, the reinforcement tape 19 can be attached to the first asphalt coated sheet 18 by any suitable means, such as other adhesives. In any of the exemplary embodiments, the reinforcement tape 19 can be formed from polyester. In other embodiments, the reinforcement tape 19 can be formed from polyolefin, such as polypropylene or polyethylene, and can include any polymeric material having the desired properties for the finished product and which endures the manufacturing environment. The reinforcement tape 19 can be formed from any material which preferably reinforces and strengthens the nail zone of a shingle, such as, by way of non-limiting example, paper, film, scrim material, and woven or non-woven fibers, such as glass, natural or polymer fibers. Alternatively, the reinforcement tape 19 can be formed of any material that does not provide such physical properties, but simply provides an indicia of the nail zone.

The second asphalt coated sheet 22 passes beneath a series of granule dispensers 24 for the application of granules to the upper surface of the second asphalt coated sheet 22. The granule dispensers 24 can be of any type suitable for depositing granules 25 onto the asphalt coated sheet. In an exemplary embodiment, a series of granule dispensers 24 can include one or more color blenders, for example, the series of granule dispensers 24 can include four color blend blenders 26, 28, 30, and 32 and a background blender 34. Any desired number of color blenders, however, can be used. Moreover, the granule dispensers 24 can dispense alternate forms of granules such as specialty granules. Specialty granules can be applied with a separate granule dispenser or can be mixed into any of the four color blend blenders 26, 28, 30, and 32 and/or the background blender 34. Alternatively, granules 25 can be dispensed onto the second asphalt coated sheet 22 by any means suitable for dispensing granules 25. After all the granules 25 are deposited on the second asphalt coated sheet 22 by the series of granule dispensers 24, the second asphalt coated sheet 22 becomes a granule covered sheet 40.

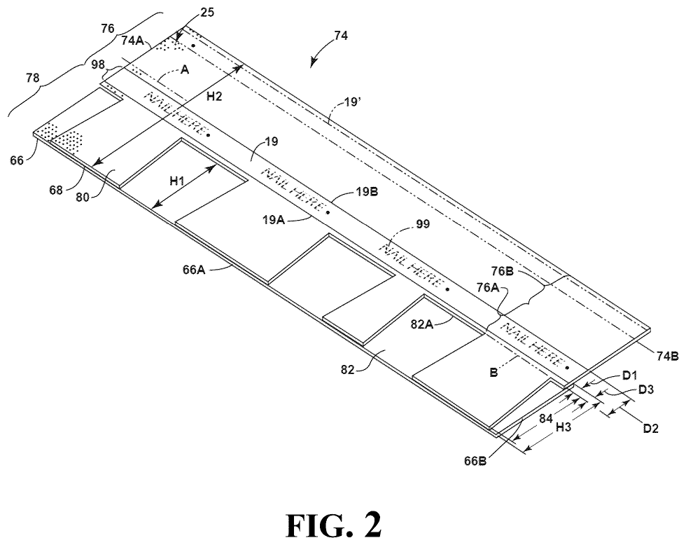

To the extent a reinforcement tape is provided, the reinforcement tape 19 can include an upper surface to which the granules 25 will not substantially adhere. The reinforcement tape 19, alternatively, can include an upper surface to which the granules 25 will adhere. For example, the apparatus 10 can include any desired means for depositing the granules 25 onto substantially the entire second asphalt coated sheet 22, except for the portion of the second asphalt coated sheet 22, covered by the reinforcement tape 19, as best shown in FIG. 2. Alternately, the granules 25 can be deposited onto substantially the entire second asphalt coated sheet 22, including the reinforcement tape 19, where the reinforcement tape 19 includes an upper surface to which the granules 25 substantially will not adhere.

The granule covered sheet 40 is turned around a slate drum 44 to press the granules 25 into the asphalt coating and to temporarily invert the granule covered sheet 40 so that the excess granules will fall off and can be recovered and reused. Next, the granule covered sheet 40 is fed through a rotary pattern cutter 52 having a bladed cutting cylinder 54 and a backup roll 56. Optionally, the pattern cutter 52 can cut a series of cutouts in the tab portion of the granule covered sheet 40, and cut a series of notches in the underlay portion of the granule covered sheet 40.

The pattern cutter 52 can also cut the granule covered sheet 40 into a continuous underlay sheet 66 and a continuous overlay sheet 68. The underlay sheet 66 can be aligned beneath the overlay sheet 68, and the two sheets 66, 68 can be laminated together to form a continuous laminated sheet 70. The continuous underlay sheet 66 can be routed on a longer path than the path of the continuous overlay sheet 68. Further downstream, the continuous laminated sheet 70 is passed into contact with a rotary length cutter 72 that cuts the laminated sheet into individual laminated shingles 74.

In order to facilitate synchronization of the cutting and laminating, various sensors and controls can be employed. For example, sensors, such as photo eyes 86 and 88 can synchronize the continuous underlay sheet 66 with the continuous overlay sheet 68. Sensors 90 can synchronize the notches and cutouts of the continuous laminated sheet 70 with the end cutter or length cutter 72.

Referring now to FIG. 2, an example laminated roofing shingle 74 is illustrated according to aspects described herein. The shingle 74 includes the overlay sheet 68 attached to the underlay sheet 66. The shingle 74 has a first end 74A, a second end 74B, and a longitudinal axis A. The overlay sheet 68 includes a headlap portion 76 and a tab portion 78. The headlap portion 76 includes a lower zone 76A and an upper zone 76B. The tab portion 78 defines a plurality of tabs 80 alternating a plurality of cutouts 82 such that each of the plurality of cutouts 82 can be located between each adjacent tab 80. By way of non-limiting example, the tab portion 78 can include four tabs 80, although any suitable number of tabs 80 can be provided. The headlap portion 76 and the tabs 80 can include one or more granule patterns thereon.

Each cutout 82 has a first height H1. As illustrated in FIG. 2, each cutout 82 has the same height H1 as another cutout 82. It will be understood, however, that each cutout 82 can have a different height H1 as another cutout 82. A line B, collinear with an upper edge 82A of the cutouts 82, defines an upper limit of an exposed region 84 of the underlay sheet 66.

In embodiments, the height of the exposed region 84 is equal to the first height H1, however, the height of the exposed region 84 may be any desired height, and the top of the cutouts 82 need not be collinear as illustrated. In a shingle 74 wherein the cutouts 82 have different first heights H1, the line B can alternatively be collinear with an upper edge 82A of the cutout 82 having the largest height H1.

The reinforcement tape 19 is located longitudinally on the headlap portion 76 from the first end 74A to the second end 74B of the shingle 74 within the blower zone 76A of the headlap portion 76. A lower edge 19A of the reinforcement tape 19 is spaced apart from the line B by a distance D1, and an upper edge 19B of the reinforcement tape 19 is spaced apart from the line B by a distance D2. By way of non-limiting example, the distance D1 is within the range of from about ¼ inch to about ¾ inch. In another example, the distance D1 is about ½ inch. In yet another example, the distance D2 is within the range of from about 1¾ inches to about 2¼ inches. In another example, the distance D2 is about 2 inches. The distances D1 and D2 can, however, be of any other desired length, including zero for D1. For example, in embodiments, the reinforcement tape 19 substantially covers the entire headlap portion 76 of the overlay sheet 68. It will be further understood, however, that one or more additional lengths of reinforcement tape 19 can be disposed longitudinally on the headlap portion 76, even outside the nail zone, such as shown by the phantom line 19′. It will be understood that the reinforcement material need not extend from the first end 74A to the second end 74B of the shingle 74, and can be disposed in one or more sections or portions on the shingle 74.

The reinforcement tape 19 can define a nail zone 98 and can optionally include indicia 99. By way of non-limiting example, the indica 99 can be text such as “nail here”, as shown in FIG. 2. It will be understood, however, that any other text or other indicia can included on the reinforcement tape 19. It will also be understood that the reinforcement tape 19 can be provided without such text or indicia. Such indicia 99 on the reinforcement tape 19 ensure that the nail zone 98 may be easily and quickly identified by the shingle installer.

The overlay sheet 68 has a second height H2. The underlay sheet 66 includes a leading edge 66A, a trailing edge 66B, and has a third height H3. The trailing edge 66B of the underlay sheet 66 is spaced apart from the line B by a distance D3. As illustrated, the distance D3 is about ⅜ inch, however, the distance D3 may be any desired distance.

The third height H3 of the underlay sheet 66 is less than one-half the second height H2 of the overlay sheet 68. The overlay sheet 68 and the underlay sheet 66 thereby define a two-layer portion of the laminated shingle 74 and a single-layer portion of the laminated shingle 74, wherein at least a portion of the reinforcement tape 19 is preferably adhered to the single-layer portion of the laminated shingle 74. Alternately, the third height H3 of the underlay sheet 66 may be equal to one-half the second height H2 of the overlay sheet 68, or greater than one-half of the second height H2 of the overlay sheet 68. Such a relationship between the underlay sheet 66 and the overlay sheet 68 allows the reinforcement tape 19 to be positioned such that a reinforced nail zone is provided at a substantially single-layer portion of the shingle 74.

In the exemplary shingle 74 illustrated in FIG. 2, the shingle 74 has a nail pull-through value, preferably measured in accordance with a desired standard, such as prescribed by ASTM test standard D3462. For example, the shingle 74 may have a nail pull-through value that is greater than in an otherwise identical shingle having no such reinforcement tape 19. The shingle 74 can have a nail pull-through value within-the range of from about ten percent to about 100 percent greater than in an otherwise identical shingle having no such reinforcement tape 19. Alternatively, the shingle 74 can have a nail pull-through value about 50 percent greater than in an otherwise identical shingle having no such reinforcement tape 19.

The granules 25 applied to the upper surface of the second asphalt coated sheet 22 can include any granule type known in the art, including conventional standard and specialty granules.

In various embodiments, the resulting shingle exhibits improved granule adhesion. Granule adhesion may be determined by following the testing methods in ASTM D4977, which is incorporated herein by reference. ASTM D4977 is a dry “as is” scrub test method for the determination of granule adhesion for granule-surfaced roofing under conditions of abrasion. The test method applies to “as manufactured” material without weathering exposure. Testing for granule adhesion may be performed by abrading the granule-coated surface of a specimen of roofing material for 50 cycles with a wire brush. The mass of the specimen of roofing material prior to abrasion is compared to the mass of the specimen of roofing material after abrasion to determine the loss in mass, which may also be referred to as scrub loss.

In certain embodiments, where the modified filler is incorporated into the asphalt composition applied to a granule-coated shingle, the shingle has a granule scrub loss of less than 1.0 g, less than 0.75 g, less than 0.60 g, less than 0.50 g, less than 0.40 g, less than 0.35 g, less than 0.30 g, less than 0.25 g, less than 0.24 g, or less than 0.23 g, when tested in accordance with ASTM D4977. In some embodiments, the shingle has a scrub loss of from 0.05 g to 1.0 g, from 0.10 g to 0.60 g, from 0.15 g to 0.50 g, from 0.15 g to 0.40 g, or from 0.15 g to 0.30 g, when tested in accordance with ASTM D4977, including any and all ranges and subranges therein.

In certain embodiments, where the modified filler is incorporated into the asphalt composition applied to a shingle, the scrub loss may be compared to the scrub loss of a comparable shingle that is identical with the exception that the filler is not modified prior to being incorporated into the asphalt composition. In embodiments, where the modified filler (in amounts and quality as described herein) is incorporated into the asphalt composition applied to a shingle, the shingle has a scrub loss according to ASTM D4977 that is less than 80%, less than 70%, less than 60%, less than 50%, or less than 40% of the scrub loss of a comparable shingle. In some embodiments, where the modified filler (in amounts and quality as described herein) is incorporated into the asphalt composition supplied to a shingles, the shingle has a scrub loss according to ASTM D4977 that is improved by greater than or equal to about 10%, greater than or equal to about 15%, greater than or equal to about 20%, greater than or equal to about 25%, greater than or equal to about 30%, greater than or equal to about 35%, greater than or equal to about 40%, greater than or equal to about 45%, greater than about 50%, greater than about 55%, or greater than about 60%, including any and all ranges and subranges therein, based on the lost mass as compared to the lost mass of a comparable shingle. For example, in some embodiments, the scrub loss according to ASTM D4977 can be improved from about 10% to about 60%, from about 15% to about 50%, or from about 20% to about 40%.

Roofing products produced using the asphalt composition described herein may also exhibit good tear resistance, which can be measured in any suitable manner. For example, the roofing shingles can have a CD tear resistance of at least about 1,100 g as measured according to ASTM D1922. In any of the exemplary embodiments, the roofing shingles may have a CD tear resistance of at least about 1.250 g, at least about 1,300 g, at least about 1,1400 g, at least about 1,500 g, at least about 1,700 grams (g), at least about 1,750 g, at least about 1,800 g, at least about 1,850 g, at least about 1,900 g, or at least about 1,950 g, including any and all ranges and subranges therein. In various embodiments, the CD tear resistance test results of the asphalt composition are comparable to (e.g., not statistically different from) or better than those of standard asphalt compositions.

Roofing products produced using the asphalt composition comprising the modified filler, as described herein, demonstrates improved bond strength performance, which may be measured in accordance with a modified ASTM D6381 standard. Improved bond strength improves, for example, granule adhesion to the asphalt and improves sealant bonds to any of the asphalt, the granules, and/or any reinforcement strips. In some exemplary embodiments, the roofing products have a bond strength at 140-70° F. of at least 18 lbs., including at least 18.5 lbs, at least 19 lbs, at least 19.5 lbs, at least 20 lbs, at least 21 lbs, at least 21.5 lbs, and at least 22 lbs.

Roofing products produced using the asphalt composition comprising the modified filler, as described herein, may further demonstrate improved thermal stability and waterproofing, through increased hydrophobicity.

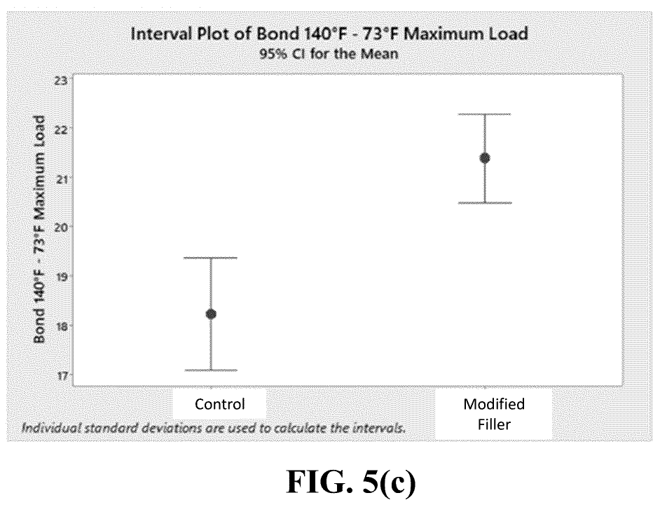

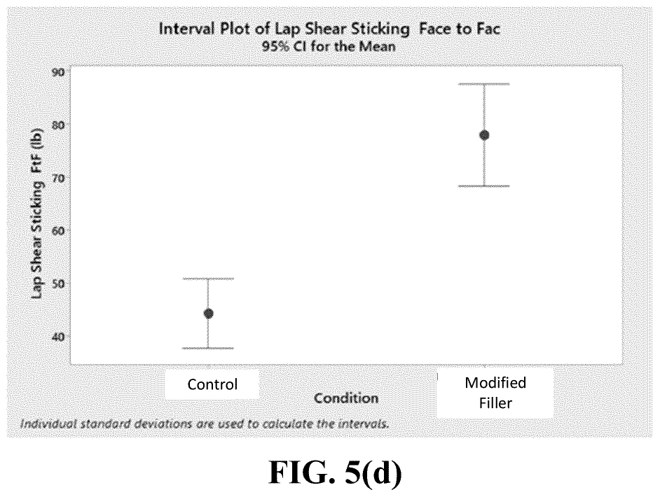

It has been surprisingly discovered that incorporating the subject modifying agent as a modifier to the filler material or as an additive to the asphalt base material directly reduces the presence of a microstructure phenomenon known as “bee structures” and raised textured asphaltene fractions (hereinafter defined as “freckles”) that often form on the surface of various types of asphalt base materials, such as is the case with oxidized asphalt. Bee structures have a bee-like patterned appearance, typically with sizes of about 10 microns or less, and exist predominantly at the asphalt surface. FIG. 6(a) illustrates a standard oxidized asphalt coating composition that includes an oxidized asphalt base material and 70 wt. % of a non-modified calcium carbonate filler. In contrast, FIG. 6(b) illustrates a coating composition comprising the same oxidized asphalt base material and 70 wt. % of calcium carbonate filler modified with calcium stearate. As shown in FIG. 6(b), the inclusion of the calcium stearate modifying agent results in the reduction and/or disappearance of bee structures and improved morphology of the asphalt surface. In some exemplary embodiments, the use of filler particles modified as described herein in asphalt coating compositions reduces the presence of bee structures at the surface of asphalt materials by at least 50%, or at least 65%, or at least 75%, or at least 85%, or at least 90% compared to an otherwise identical asphalt coating compositions that include traditional, non-modified filler particles.

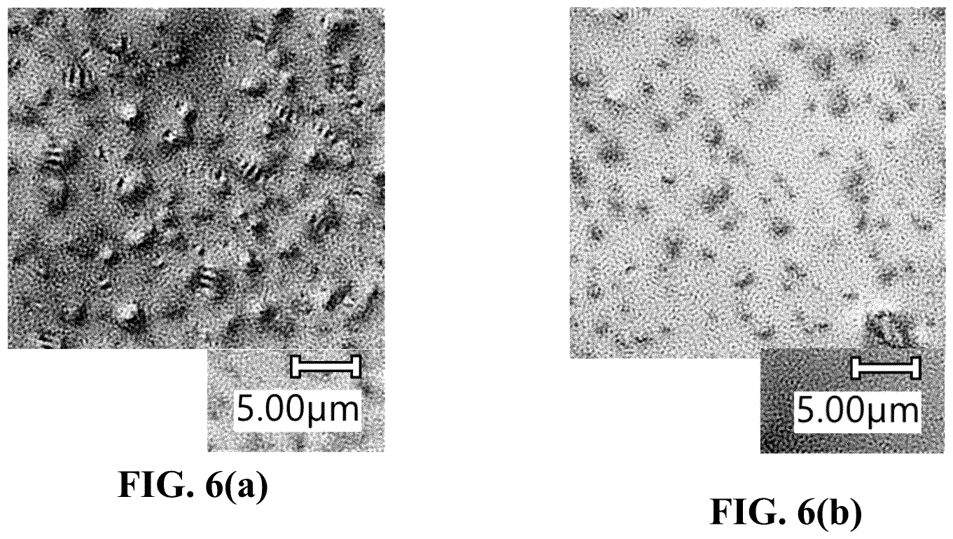

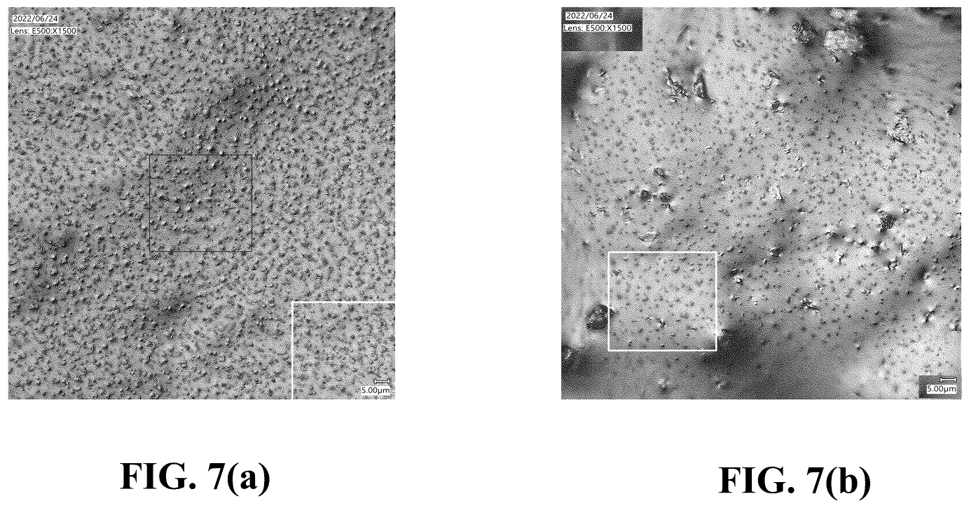

The inclusion of the modifying agent further results in a reduction in the raised asphaltene fractions or “freckles” mentioned above that often form at the surface of asphalt materials, along with the bee structures. Not intending to be bound by theory, it is believed that these freckles are related to the presence of asphaltenes, which are the most polar fraction in bitumen and asphalt materials. FIG. 7(a) illustrates a standard oxidized asphalt coating composition that includes 70 wt. % of a non-modified calcium carbonate filler. In contrast, FIG. (7b) illustrates an asphalt coating composition comprising the same oxidized asphalt base material and 70 wt. % of calcium carbonate filler modified with calcium stearate. As illustrated by FIGS. 7(a) and 7(b), the freckles in the asphalt of FIG. 7(a) are present at a higher density than that of FIG. 7(b). Although not intended to be bound by theory, it is believed that the modifying agent breaks up asphaltene aggregates and thus the asphaltenes are more homogenously distributed throughout the asphalt coating composition and there is less of a presence of these fractions at the surface of the asphalt. In any of the exemplary embodiments, the addition of the aforementioned modifying agent results in a reduction of visible asphaltene fractions or freckles at the asphalt surface by at least 10%, including at least 15%, at least 20%, at least 23%, and at least 25%, compared to an otherwise identical asphalt coating that does not include the modifying agent.

A 33.94 micron×34.09 micron sample size (1,157.025 square micron area density) was analyzed from FIG. 7(a) (illustrated by white box at lower right corner) and a 33.78 micron×33.94 micron sample size (1,146.740 square micron area density) was analyzed from FIG. 7(b) (illustrated by white box at lower left corner). The sample sizes were then analyzed for freckle density and the Percent Void was determined by taking the total area density and subtracting the density of the freckles within the area. The Percent Void for the sample size in FIG. 7(a) was 68.70% and the Percent Void calculated for the sample size in FIG. 7(b) was 92.27%, indicating a much lower presence of freckles (23.57%).

### EXAMPLES

### Example 1

Various modifying agents (calcium hydroxide (Ca(OH)₂), calcium stearate (CaSt) in solid particulate form, or calcium stearate as a 50% emulsion) were used to coat a calcium carbonate filler material having a D₅₀ of 20-60 μm and a D₉₀ of 140-160 μm that was then added to an oxidized asphalt coating composition having a softening point between 190° F. and 235° F. and a penetration of 15 dmm, as set forth in Table 1. Each sample below included the same asphalt base material and filler material, prior to modification.

TABLE 1

| Sample | Modifier | % Filler | % Modifier |
|---|---|---|---|
| Comparative Sample A | N/A | 66% | 0 |
| Sample 1 | Ca(OH)₂ | 69.68% | 0.32% |
| Sample 2 | CaSt | 68.62% | 0.31% |
| Sample 3 | CaSt | 69.68% | 0.32% |
| | (emulsion) | | |

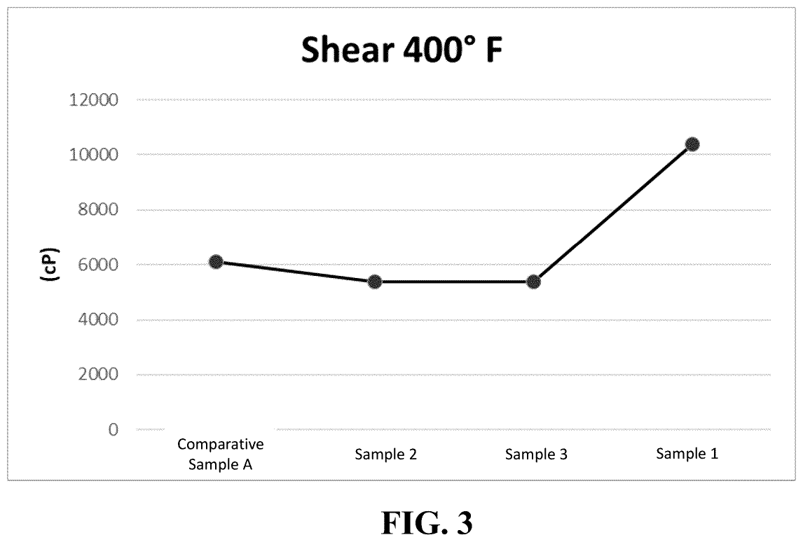

For each sample, the shear viscosity (at 400° F.) was tested, and the results are shown in FIG. 3. The shear viscosity property is indicative of processing temperatures and overall processability. High shear viscosity values indicate the need for higher processing temperatures and potential processing issues. Shear viscosity was tested using a Rosand RH2000 Capillary Rheometer.

As shown in FIG. 3, shear viscosity for Samples 2 and 3 was decreased as compared to Comparative Sample A, and, although slightly increased for Sample 1, the shear viscosity remained below 12,000 cP, which is within the desired range specification.

Additionally, the flowability of the modified fillers in Samples 1-3 was above 95% and each Sample exhibited a bulk density around 50-65 lbs/ft³. The surface energy of each Sample was above 50 mN/m, which indicates that the material is hydrophilic. The oil absorption is around 15-20 grams per 100 grams of filler, measured in accordance with ASTM D281. The modified filler particles are similar in size to conventional filler particles, while demonstrating an increase in bulk density, oil absorption and flowability. The modified filler demonstrates a significant decrease in surface energy to 10-30 mN/m, indicating that the modified filler is hydrophobic. The hydrophobicity of the modified filler can help repel the moisture in the filler, which is an important aspect in the manufacturing process.

### Example 2

Additional samples and comparative samples (six of each) were prepared to further explore use of calcium stearate emulsion as a modifying agent for a filler material. To improve mixing efficiency, wet calcium stearate was mixed with a partial amount of standard calcium carbonate filler having an average particle size between 20 μm and 160 μm and permitted to dry overnight. Then, the dried filler modified with calcium stearate was mixed with the rest of the filler in a cement mixer overnight. The resultant filler was then mixed with oxidized asphalt to form the filled coating with modified filler. Comparative Samples B-G included 66 wt. % standard filler. Samples 4-9 included 67.68 wt. % filler and 0.32 wt. % modifier.

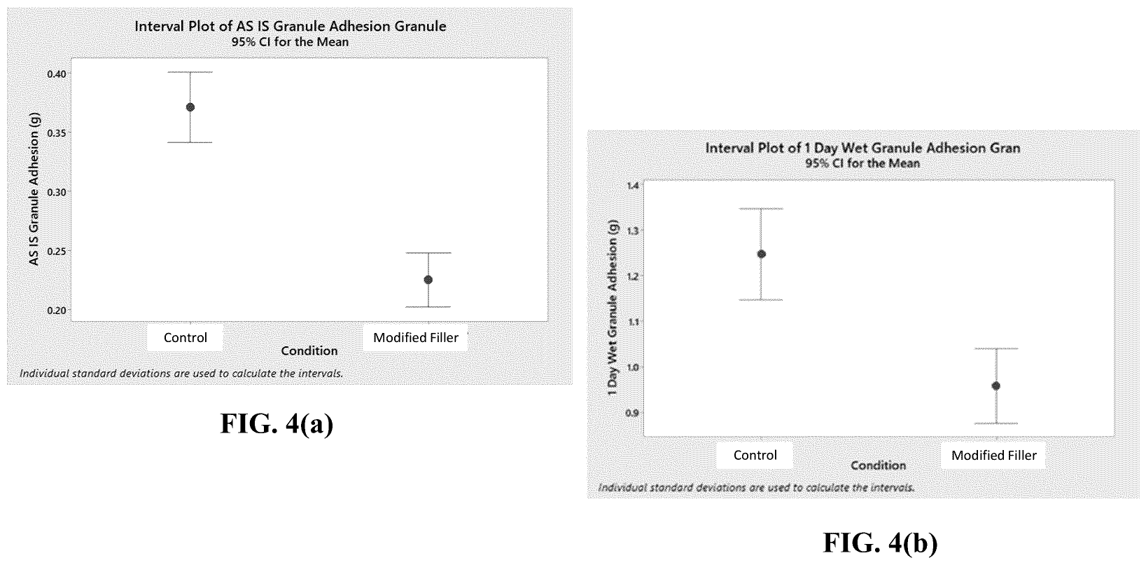

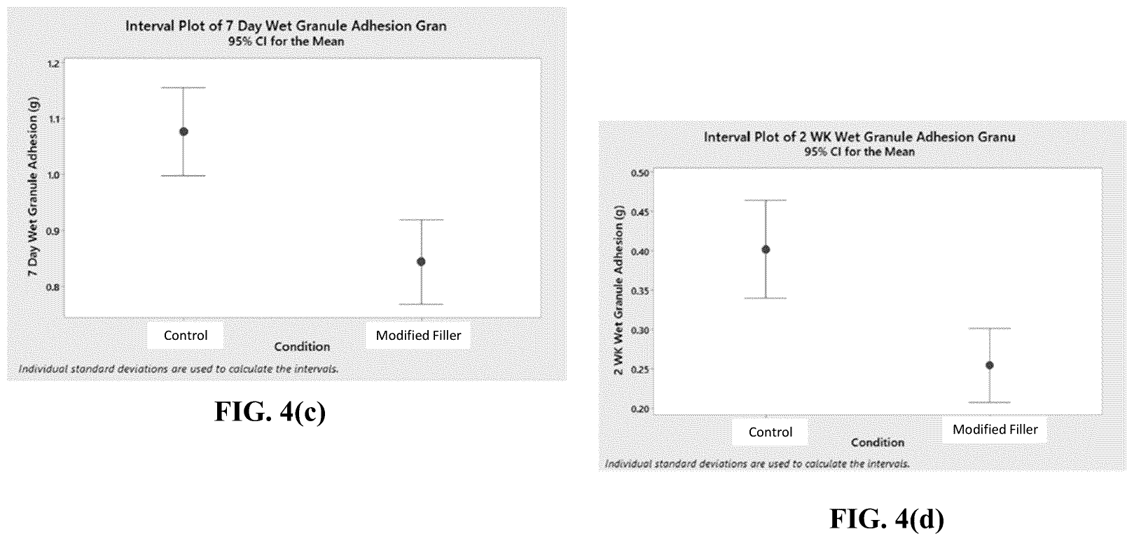

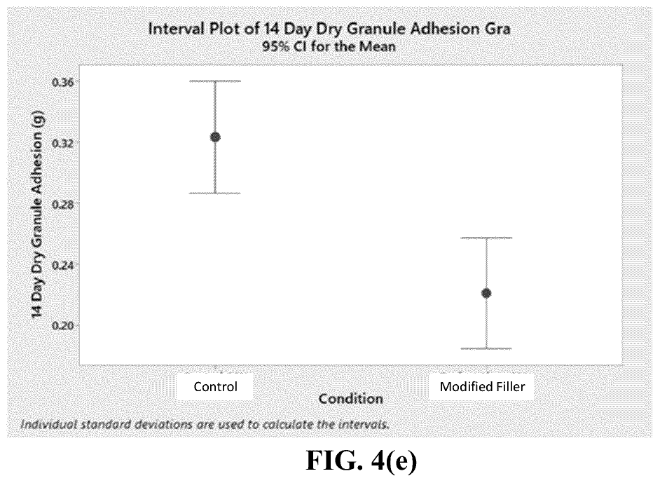

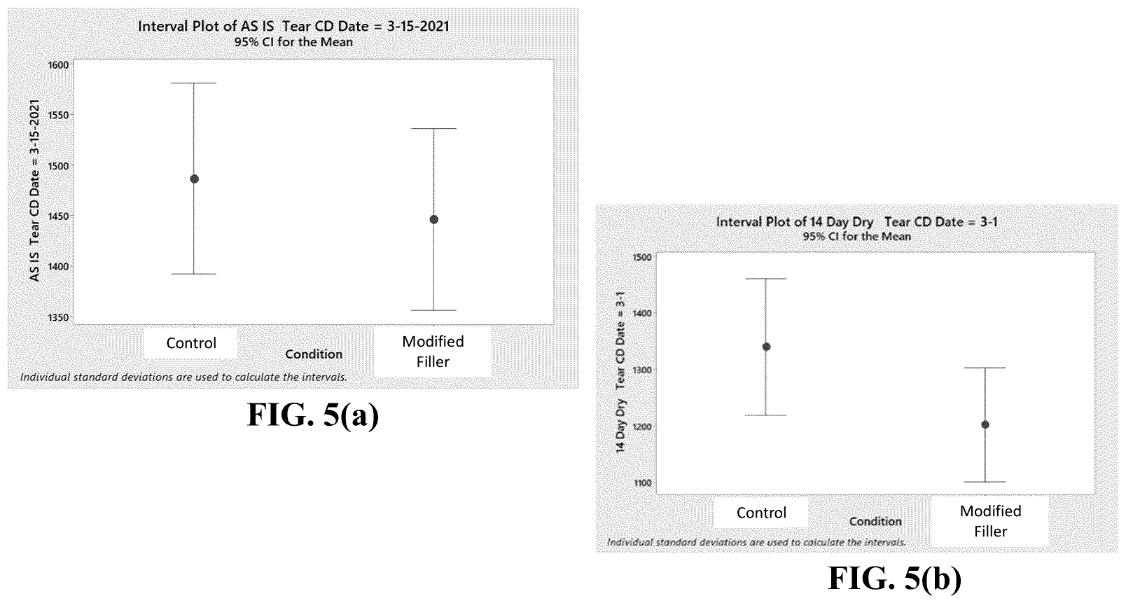

The resultant sample coatings were applied to a shinglet sample and standard granules were applied. Granule adhesion, CD tear resistance, and bond strength were tested for comparison purposes. Bond strength was test in accordance with a modified ASTM D6381 standard. The average results are reported in Table 2 (results are based on testing shinglet samples in a lab and not full shingle coupons). Thus, the results are for purposes of comparison only and not commensurate with standard shingle properties). Granule adhesion results are shown in FIGS. 4 (a)-(e). CD tear resistance results are shown in FIGS. 5(a) and (b). Bond performance results are shown in FIG. 5(c) and lap shear sticking performance is shown in FIG. 5(d).

TABLE 2

| | | 2% Filler | |
|---|---|---|---|
| | Control | Increase | Δ % |
| Granule Adhesion | 0.371 | 0.225 | −39% |
| (g) Upon Application | | | |
| Granule Adhesion (1 day wet) | 1.25 | 0.95 | −24% |
| Granule Adhesion (7 day wet) | 1.09 | 0.85 | −22% |
| Granule Adhesion (2 week | 0.4 | 0.25 | −37% |
| wet) | | | |
| Granule Adhesion (14 day dry) | 0.32 | 0.22 | −31% |
| CD Tear Resistance | 1486 | 1446 | −3% |
| (g) (As-Is) | | | |
| CD Tear Resistance (g) (14- | 1330 | 1200 | −10% |
| day dry test) | | | |
| Bond Strength | 18.2 | 21.4 | 18% |
| (140-70° F.) (lbs.) | | | |

As demonstrated by the data of Table 2, the modification of the filler enables a significant improvement in granule adhesion (e.g., a significant decrease in scuff loss). Additionally, the CD tear resistance of the shingle was not significantly impacted, and the bond strength was significantly improved. Accordingly, the examples demonstrate that by modifying the filler, the filler content of the asphalt composition can be increased while providing improved granule adhesion and bond strength, while not detrimentally impacting the CD tear resistance of the shingle. In addition to providing various mechanical advantages, it should be appreciated that increasing the filler content may lead to cost savings in some implementations.

### Example 3

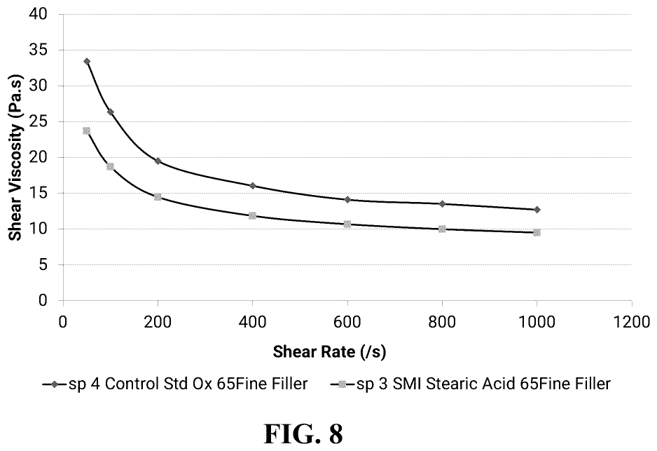

An exemplary asphalt coating sample comprising stearic acid modified filler (Sample 4) was prepared, along with a comparative asphalt coating sample that included standard oxidized asphalt with 66 wt. % fine calcium carbonate filler (Comparative Example B). The exemplary sample included the same oxidized asphalt and fine calcium carbonate filler, as Sample 4 but the filler was pre-treated with a modifying agent comprising 65 wt. % solids of stearic acid. The fine calcium carbonate filler had an average particle size of 5 microns. FIG. 8 illustrates the shear viscosity per shear rate for each sample measured using an RH2000 Capillary Rheometer. As illustrated in FIG. 8, Sample 4 demonstrated a decreased shear viscosity over the same shear rate as Comparative Example B. Thus, the use of the stearic acid modifying agent lowered the shear viscosity across relevant shear rates in processing, which is important for the manufacturing process. Typically, the amount of filler material that can be included in an asphalt coating is limited because doing so leads to higher shear viscosity that requires more force and energy to pump asphalt in a roofing plant. By including the modifying agent, the overall shear viscosity of the coating can be reduced, which allows for the use of a higher filler content without having to adjust process controls.

### Example 4

Further exemplary asphalt coating samples were prepared comprising oxidized asphalt and 70 wt. % of calcium carbonate filler modified with calcium stearate (Sample 5) and 67 wt. % of calcium carbonate filler modified with stearic acid (Sample 6). Two comparative asphalt coating samples were also prepared that included identical oxidized asphalt with 66 wt. % (Comp. Ex. C) and 70 wt. % (Comp. Ex. D) non-modified calcium carbonate filler, respectively. The adhesion of each asphalt coating sample was tested via a probe tack test, whereby a metal probe is lowered to touch an asphalt coating using a consistent force of 300 g for 1 second contact time. The probe is then raised at a constant speed of 0.5 mm/s at 140° F., with a trigger force of 5 grams. The force needed to lift the probe from the coating is then measured. The more force required to separate the probe from the coating indicates a higher force of adhesion and thus a stickier asphalt. A higher force of adhesion is beneficial for granule adhesion, but a balance must be struck to minimize shingle bundle sticking when multiple shingles are stacked on top of each other.

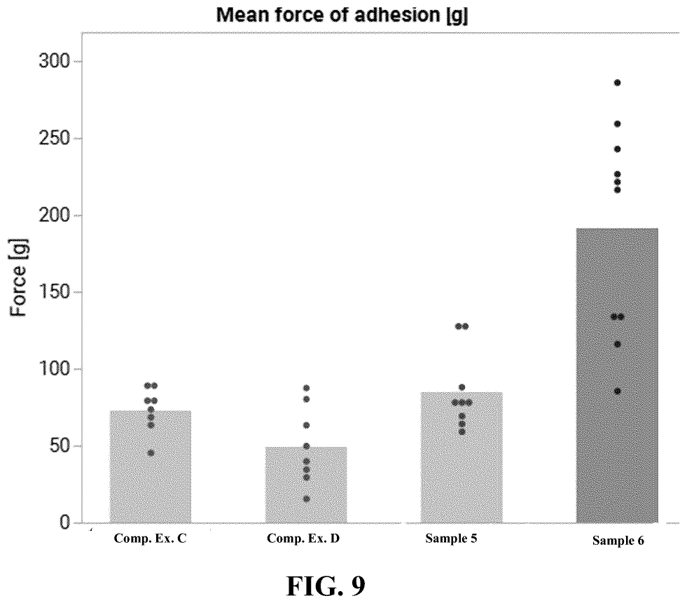

FIG. 9 illustrates the force of adhesion demonstrated by each sample. Sample 5 illustrated a mean force of adhesion of about 75 grams, while Sample 6 illustrated a mean force of adhesion of close to 200 grams (about 195 grams). In contrast, Comparative Samples C and D demonstrated mean force of adhesion levels of about 70 grams and about 50 grams, respectively, indicating a drop in adhesion with increased filler content. Although Sample 5 demonstrated a lower force of adhesion compared to Sample 6, Sample 5 demonstrated an improvement over both Comparative Examples C and D, with a high filler content of 70 wt. %.

### Example 5

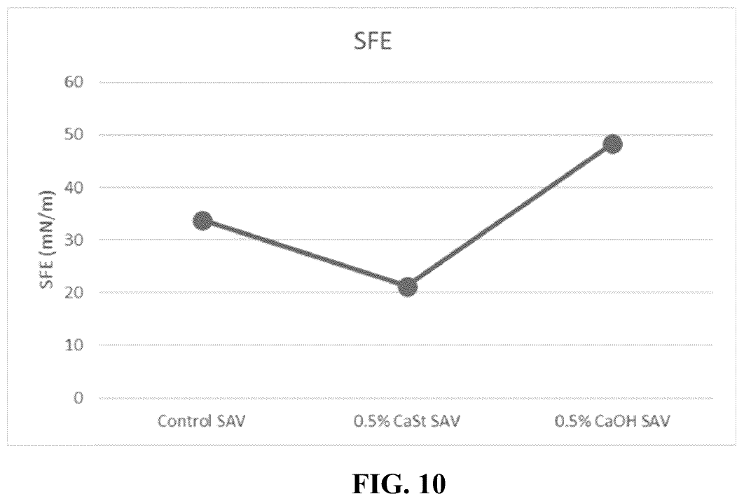

Filler samples were prepared by premixing 0.5 wt. % modifier (either calcium stearate or calcium hydroxide) with calcium carbonate particles. A control was also prepared comprising unmodified calcium carbonate filler. The samples were tested on an optical tensiometer for surface free energy. As illustrated in FIG. 10, the calcium stearate modified filler demonstrated a lower surface energy (about 21 mN/m) than the control (about 33 mN/m), while the calcium hydroxide modified filler demonstrated a higher surface energy (about 49 mN/m).

### Example 6

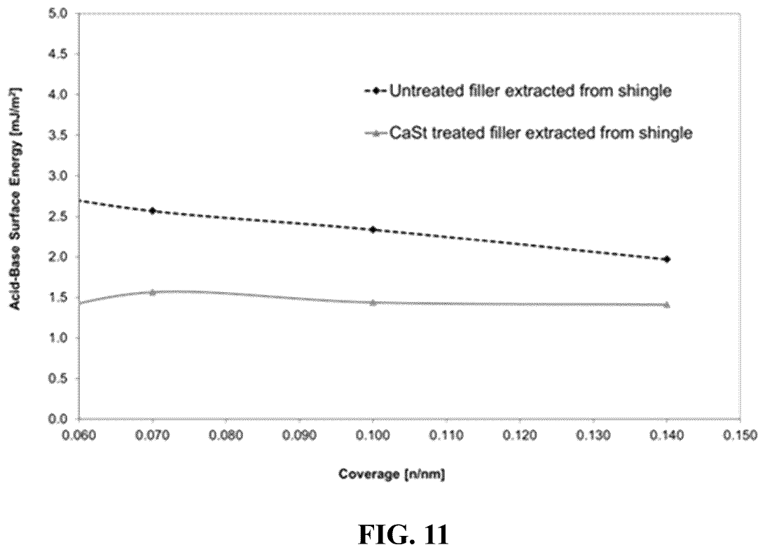

Filler samples were prepared by premixing 0.5 wt. % calcium stearate modifier with calcium carbonate particles. A control was also prepared comprising unmodified calcium carbonate filler. One gram of extracted treated filler (or unmodified filler for the control) was packed into an inverse gas chromatography column built specific for powder/granule substrates. The relative humidity and temperature were controlled at 0% and 30° C., respectively. Gaseous probe molecules (dichloromethane, ethyl acetate, acetone, acetonitrile, and ethanol) were sent into the filler packed column with a nitrogen gas carrier. Total surface area of the filler particles was determined. Dispersive surface energy and acid-base surface energy were measured as a function of coverage on the filler particles by probe molecules. FIG. 11 illustrates the acid-based surface energy as a function of probe molecule coverage on the filler particles. The steady state acid-base surface energy of the calcium stearate treated filler was 1.44±0.02 mJ/m², whereas the acid-based surface energy of untreated filler was 2.33±0.02 mJ/m². This indicates that the surface of untreated filler is more polar or more hydrophilic than that of the untreated filler.

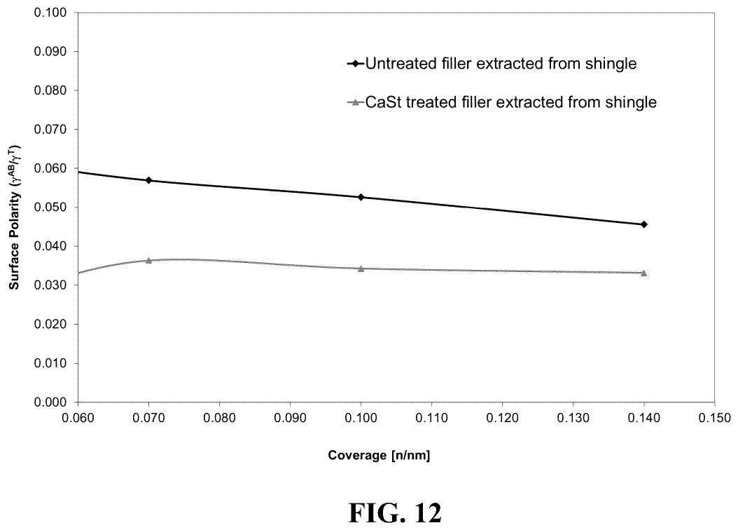

The surface polarity index of the samples was then calculated and illustrated in FIG. 12. The surface polarity index also shows untreated filler (surface polarity index of 0.053) to be more susceptible to wetting than the treated filler (surface polarity index of 0.034). The surface polarity index is calculated by dividing the acid-base surface energy with the total dispersive and acid-base surface energy measured.

To the extent not already described the different features and structures of the various embodiments of the present disclosure may be used in combination with each other as desired. For example, one or more of the features illustrated and/or described with respect to one aspect of the disclosure can be used with or combined with one or more features illustrated and/or described with respect to other aspects of the disclosure. That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly described.

While aspects of the present disclosure have been specifically described in connection with certain specific embodiments thereof, it is to be understood that this is by way of illustration and not of limitation. Reasonable variation and modification are possible within the scope of the forgoing disclosure and drawings without departing from the spirit of the present disclosure which is defined in the appended claims.

What is claimed is:

1. A roofing shingle comprising:
an asphalt-coated sheet comprising an asphalt coating composition disposed on a substrate, wherein at least a portion of the asphalt-coated sheet comprises a plurality of granules disposed thereon, wherein the asphalt coating composition comprises:
greater than about 40 wt. % of a filler, based on the weight of the total solids content of the asphalt composition;
from about 0.01 wt. % to about 10 wt. % of at least one modifying agent comprising a fatty acid, a metal hydroxide, a salt of a fatty acid, or mixtures thereof, based on the weight of the total solids content of the asphalt composition; and
asphalt;
wherein the roofing shingle has a CD tear resistance of at least about 1,700 g as measured according to ASTM D1922 and a granule scrub loss of less than 1.0 g as measured according to ASTM D4977.

2. The roofing shingle according to claim 1, wherein the salt of a fatty acid is a metal stearate and the fatty acid is stearic acid, lauric acid, myristic acid, palmitic acid oleic acid, linoleic acid, or mixtures thereof.

3. The roofing shingle according to claim 1, wherein the modifying agent is stearic acid, calcium stearate, zinc stearate, calcium hydroxide, or mixtures thereof.

4. The roofing shingle according to claim 1, wherein the modifying agent is free of an amine.

5. The roofing shingle according to claim 1, wherein the filler comprises one or more of ground limestone, dolomite, silica, talc, sand, cellulosic materials, fiberglass, or calcium carbonate.

6. The roofing shingle according to claim 1, wherein the filler is at least partially coated with the at least one modifying agent.

7. The roofing shingle according to claim 1, wherein the granule scrub loss according to ASTM D4977 is improved by greater than or equal to about 10% based on a lost mass as compared to a lost mass of a comparable shingle not including the modifying agent.

8. The roofing shingle according to claim 1, wherein the filler is present in the asphalt coating composition in an amount of greater than about 68 wt. %.

9. The roofing shingle according to claim 1, wherein the filler is present in the asphalt coating composition in an amount of greater than or equal to 70 wt. %, based on the weight of the total solids content of the asphalt composition.

10. The roofing shingle according to claim 1, wherein the modifying agent is present in the asphalt coating composition an amount of from about 0.10 wt. % to about 1.8 wt. %, based on the weight of the total solids content of the asphalt composition.

11. The roofing shingle according to claim 1, wherein the modifying agent is present in the asphalt coating composition in an amount that is less than or equal to 1.0 wt. %, based on the weight of the total solids content of the asphalt composition.

12. The roofing shingle according to claim 1, wherein the CD tear resistance is greater than or equal to about 1,900 g.

13. A method of manufacturing an asphalt-coated sheet, the method comprising:
combining a filler and at least one modifying agent selected from fatty acids, salts of fatty acids, metal hydroxides, and mixtures thereof, to form a modified filler, the modified filler having one or more of the following properties: 1) a surface free energy of no greater than 33 mN/m, measured using a tensiometer; 2) an acid-base surface energy of no greater than 2 mJ/m² measured using inverse gas chromatography; and 3) a surface polarity index of no greater than 0.04;
combining the modified filler with asphalt to form an asphalt coating composition; and
applying the asphalt coating composition to a substrate, thereby forming an asphalt-coated sheet,
wherein the filler is included in an amount of greater than about 65 wt. % based on a total weight of the asphalt coating composition and the modifying agent is included in an amount of from about 0.05 wt. % to about 2 wt. %, based on the weight of the total solids content of the asphalt composition.

14. The method of claim 13, wherein the salt of fatty acid is a metal stearate and the fatty acid is stearic acid, lauric acid, myristic acid, palmitic acid oleic acid, linoleic acid, or mixtures thereof.

15. The method of claim 13, wherein modifying agent is stearic acid, calcium hydroxide, calcium stearate, or zinc stearate.

16. The method of claim 13, wherein the modifying agent is free of an amine.

17. The method of claim 13, wherein the modifying agent is in powder form.

18. The method of claim 13, wherein the modifying agent is in liquid form.

19. The method of claim 13, wherein the asphalt is non-oxidized asphalt.

20. An asphalt-coated sheet having improved surface morphology comprising:
an asphalt coating composition disposed on a substrate, the asphalt coating composition having a top surface, wherein the asphalt coating composition comprises:
greater than about 68 wt. % of a filler, based on the weight of the total solids content of the asphalt composition;
from about 0.05 wt. % to about 2 wt. % of at least one modifying agent comprising a fatty acid, a metal hydroxide, a salt of a fatty acid, or mixtures thereof, based on the weight of the total solids content of the asphalt composition; and
asphalt;
wherein the asphalt coating composition includes reduction in the presence of visible asphaltene fractions raised at the top surface by at least 20%, compared to an otherwise identical asphalt-coated sheet not including the modifying agent.
